(19) United States
(12) Patent Application Publication
(10) Pub. No.: US 2007/0143834 A1
(43) Pub. Date: Jun. 21, 2007

(54) User authentication in a communication system supporting multiple authentication schemes

(75) Inventors: Anu Leinonen, Tampere (FI); Kalle Tammi, Nokia (FI); Minna Myllymaki, Tampere (FI); Gabor Ungvari, Gyal (HU); Kari Einamo, Suinula (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/635,555

(22) Filed: Dec. 8, 2006

(30) Foreign Application Priority Data
Dec. 20, 2005 (EP) 05027890.2

(51) Int. Cl. H04L 9/32

(52) U.S. Cl. 726/5

(57) ABSTRACT

Authentication of a user of a communication system comprising a session control server and an authentication server, wherein the communication system supports at least two separate authentication schemes, comprising the steps of determining, at the session control server, that a registration request from the user to be authenticated leaves undefined the authentication scheme to be used for authenticating the user; and inquiring, from the authentication server, which authentication scheme is to be used for authenticating the user, said inquiring being based on an identity of the user and pre-stored information at the authentication server on a mapping between user identities and usable authentication schemes.

### FIELD OF THE INVENTION

The present invention relates to user authentication in a communication system supporting multiple authentication schemes. In particular, the present invention relates an authentication of a user of a communication system comprising a session control server and an AAA server, wherein the communication system supports at least two separate authentication schemes.

### BACKGROUND OF THE INVENTION

In recent years, communication technology has widely spread in terms of number of users and amount of use of the telecommunication services by the users. This also led to an increase in the number of different technologies and technological concepts in use.

Accordingly, there is a need for convergence of networks and systems based on such different technologies and technological concepts into overall network systems. Examples for such different technologies may include GPRS (General Packet Radio Service) or CDMA (Code Divisional Multiple Access) or, in general, IP-based (IP: Internet Protocol) networks. Further, there is a need for convergence of different services, functions and applications into overall network systems. Such converged network systems are often referred to as next generation networks. Examples for such next generation networks include networks specified by 3GPP (Third Generation Partnership Project) or IETF (Internet Engineering Task Force).

For ensuring security and trustiness within such overall communication systems, which is particularly important for functions and services related to security-relevant, personal and/or confidential data, and for controlling access to such network systems and parts thereof, an user authentication is usually performed. However, there is a problem in that such an user authentication is to be performed for any subnetwork or subsystem within an overall communication system, to which e.g. a user whishes to get access, and in that different subnetworks or subsystems may employ different authentication schemes which are not compatible to each other. Stated in more general terms, there arise problems based on heterogeneous operation processes within an overall communication system.

For example, an IP Multimedia Subsystem (IMS) is conceivable as a present example for such a communication system. In FIG. 1 of the accompanying drawings, a basic overview of an IMS architecture is illustrated, however only depicting those network elements which are relevant for the subsequent description.

A terminal denoted by UE (for user equipment) is able to access the IMS network via an access network, two of which are shown as an example, and a proxy call session control function P-CSCF. All or some P-CSCFs of the IMS network are interconnected via an interrogating call session control function I-CSCF. Further, the P-CSCFs each are connected to a serving call session control function S-CSCF, which is also connected to the I-CSCF. The S-CSCF and the I-CSCF both are connected to a home subscriber server HSS. The interface between a call session control function CSCF and a home subscriber server HSS is usually referred to as Cx interface, as indicated in FIG. 1.

Details about the signaling flow and message contents on the Cx interface are described e.g. in the document “3GPP TS 29.228, v6.8.0” of September 2005. Similarly, the conventional function and operation of the network elements illustrated in FIG. 1 are as such known to a skilled person, and will thus not be described herein.

In an IMS network, the session initiation protocol (SIP) specified by the IETF is usually employed as a session control protocol, and the Diameter protocol specified by the IETF is usually employed as an authentication, authorization and accounting (AAA) protocol. Hence, the HSS may act as a Diameter server and the CSCFs may act as SIP servers. In this connection, the IMS defines a Diameter application to interact with the SIP during session setup and other ones to perform and/or control other SIP services. As regards the Cx interface between a CSCF and a HSS, as depicted in FIG. 1, the details thereof based on the Diameter protocol are described e.g. in the document “3GPP TS 29.229, v6.6.0” of September 2005.

In this regard, there has been proposed a Diameter SIP application in the Internet-draft “draft-ietf-aaa-diameter-sip-app-10” of Oct. 21, 2005. This proposal describes an interworking of Diameter and SIP in that a SIP server relies on Diameter AAA infrastructure for authenticating a SIP request (for example, a SIP registration request such as SIP REGISTER) and authorizing the usage of particular SIP services.

An IMS network such as that shown in FIG. 1 is for example operable in association with a GPRS-based access network and an IP-based access network in which a hypertext transfer protocol (HTTP) is used for communication.

For providing security, i.e. authentication, in an IMS-related network environment, there has been proposed a solution usually referred to as “Early IMS Security”. This solution is e.g. disclosed in the document “3GPP TS 33.978, v.6.1.0 (Release 6)” of June 2005. The thus disclosed solution provides for an access-level bundled authentication for a 3GPP architecture, and it is only applicable to GPRS-based network access.

In an IP-related network environment, there has been proposed a solution for providing security, i.e. authentication, which is usually referred to as “HTTP Digest authentication”. This solution is e.g. disclosed in RFC2617 of the IETF, and utilizes cryptographic hashes for authentication. For example, the above-mentioned Diameter SIP application supports HTTP Digest as the only authentication scheme in SIP.

According to the specification of the Early IMS security, for example, a registration request such as a SIP REGISTER message can be sent with or without a so-called authorization header, which is normally required for defining information on authentication and authorization schemes to be employed. If the S-CSCF receives such a SIP REGISTER message without an authorization header, it knows based on the missing authorization header that Early IMS Security is the authentication scheme in question. Accordingly, it sends a multimedia authentication request (MAR) command towards the HSS so that a predetermined information element in the MAR command, which regards the authentication scheme (e.g. attribute-value-pair “Authentication-Scheme” within grouped attribute-value-pair “SIP-Auth-Data-Item”), contains Early IMS Security as the authentication scheme to be used for authenticating the user.

However, in the above case of two different access networks, the S-CSCF supports two separate authentication schemes, i.e. both Early IMS Security (for the GPRS access network) and HTTP Digest authentication (for the IP-based access network). In addition to the Early IMS Security, also according the specification of the HTTP Digest authentication, the authorization header can be missed out. Accordingly, when a S-CSCF supporting both schemes receives a SIP REGISTER message without authorization header, it does not know and does not have an possibility to find out which authentication scheme to use for authenticating the user.

As indicated above, especially in convergence networks, this unresolvable ambiguity poses an essential problem for the operation of heterogeneous communication systems.

There has not been presented any prior art solution in this regard.

Thus, a solution to the above problem is needed for providing a viable and reliable user authentication in a communication system supporting multiple authentication schemes.

### SUMMARY OF THE INVENTION

Consequently, it is an object of the present invention to remove the above problem/drawback inherent to the prior art and to provide accordingly improved methods, network elements, computer program product as well as an accordingly improved system and signal.

According to aspects of the invention, this object is for example achieved by a method of authentication according to claim 1, a method of authentication according to claim 20, a session control server according to claim 27 or claim 32, an authentication server according to claim 37 or claim 45, a system according to claim 53, a computer program according to claim 57 or claim 58, and/or a signal according to claim 59.

According to further aspects of the present invention, the above object is for example also achieved by a method of authentication according to any one of claims 60, 62, and/or 64.

Further advantageous developments are set out in respective dependent claims.

It is an advantage of the present invention that a user authentication in a communication system supporting multiple authentication schemes is provided.

This is particularly advantageous when the at least two authentication schemes are of different types, such as of 3GPP type and IETF type.

With the embodiments of the present invention, a session control server such as a CSCF in an IMS environment is enabled to find out the authentication scheme to be used.

It is a further advantage of the embodiments of the present invention that no changes to existing specifications and message formats are required. Thus, the embodiments of the present invention can be implemented in an easy and inexpensive manner.

### BRIEF DESCRIPTION OF THE DRAWINGS

In the following, the present invention will be described in greater detail with reference to the accompanying drawings, in which

FIG. 1 shows a basic overview of an IMS architecture;

FIG. 2 shows a signaling diagram of an authentication method according to a first embodiment of the present invention;

FIG. 3 shows a schematic block diagram of a session control server and an AAA server according to a first embodiment of the present invention;

FIG. 4 shows a signaling diagram of an authentication method according to a second embodiment of the present invention; and

FIG. 5 shows a schematic block diagram of a session control server and an AAA server according to a second embodiment of the present invention.

### DETAILED DESCRIPTION OF EMBODIMENTS OF THE PRESENT INVENTION

The present invention is described herein with reference to a particular non-limiting example. A person skilled in the art will appreciate that the invention is not limited to this example and may be more broadly applied.

In particular, the present invention is described in relation to a Diameter SIP application which is used for offering authentication and authorization services of a Diameter server for SIP servers. In this regard, SIP is used as a particular example of a session control protocol and Diameter is used as a particular example of an AAA protocol. In the particular 3GPP architecture, the present invention is applicable to the IP Multimedia Subsystem (IMS) as well as to a Push-to-talk-over-Cellular (PoC) service. In particular, in accordance with the described example scenario, the present invention mainly relates to the Cx interface between a home and a call session control function CSCF acting as a session control (SIP) server. Such terminology is however only used in the context of the presented examples and does not limit the invention in any way.

### Solution According to a First Embodiment of the Present Invention

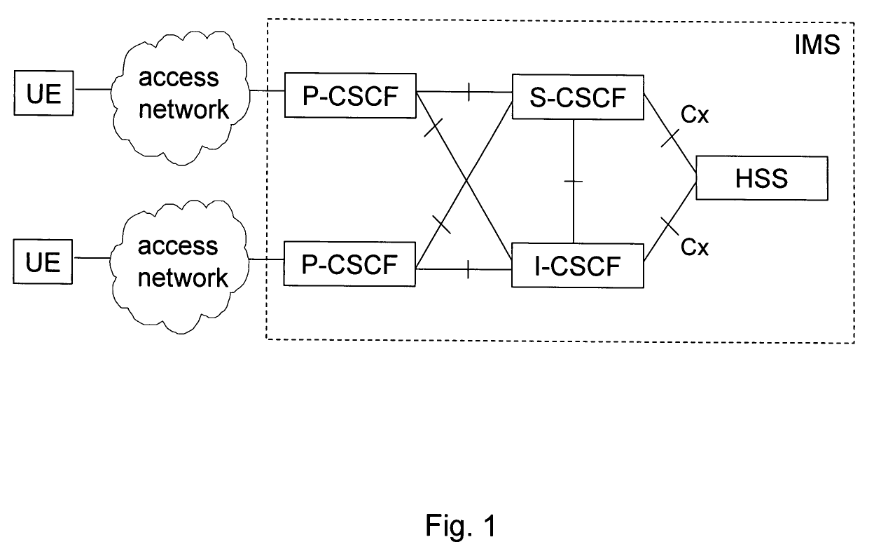

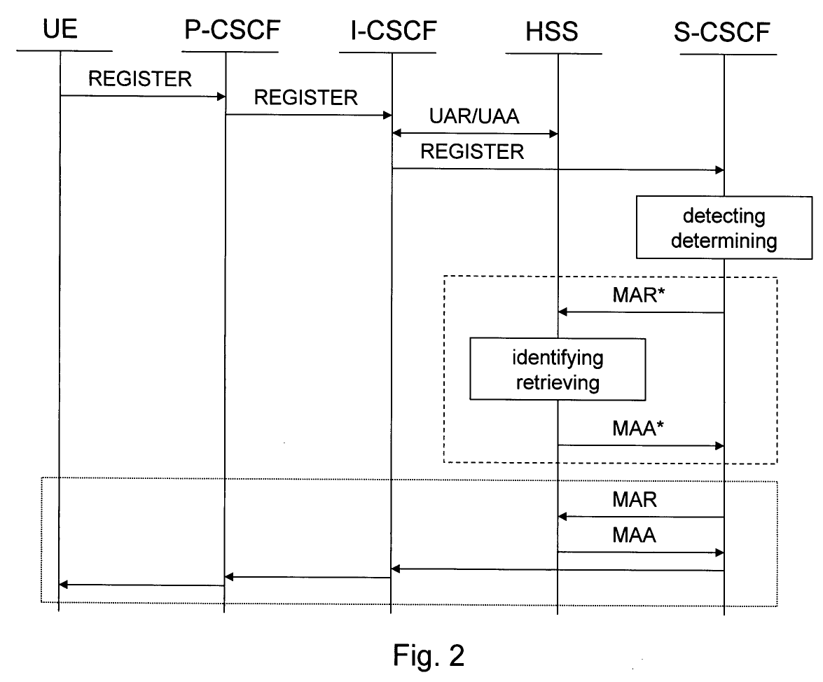

FIG. 2 shows a signaling diagram of an authentication method according to an embodiment of the present invention, which is in line with the architecture according to FIG. 1.

A user which is illustrated by a user equipment UE wants to register and thus sends a registration request exemplified as a SIP REGISTER message to the P-CSCF, which forwards this message to the I-CSCF of the IMS network. The I-CSCF performs a user authorization operation by exchanging an user authorization request UAR and an user authorization answer UAA with the HSS. The conventionally known user authorization operation is, for example, for filtering a public user identity contained in the SIP REGISTER message, for deciding whether there is an S-CSCF already allocated to the UE, or the like. Subsequently, the I-CSCF forwards the registration request SIP REGISTER to the appropriate S-CSCF which, according to the underlying network scenario, supports at least two authentication schemes. It is assumed that the registration request does not contain an authorization header, which is e.g. allowed in Early IMS Security and HTTP Digest authentication. Accordingly, the request lacks information on which authentication scheme is to be used for authenticating the user.

According to the present embodiment, the session control server S-CSCF detects that the registration request does not contain an authorization header, and thus determines that a registration request from the user to be authenticated leaves undefined the authentication scheme to be used for authenticating the user. Then, the S-CSCF starts inquiring which authentication scheme is to be used for authenticating the user, wherein the inquiring procedure of the present embodiment is depicted by a dashed box in FIG. 2.

Generally, the inquiring is based on an identity of the user and pre-stored information at the AAA server on a mapping between user identities and usable authentication schemes.

According the present embodiment, the S-CSCF sends an authentication request message to the AAA server HSS. In the depicted example, the authentication request message has the format of a multimedia authentication request (MAR) command. In this MAR command denoted by MAR* in FIG. 2, a predetermined information element regarding the authentication scheme is set to a specific value indicating that the authentication scheme to be used is inquired. In the depicted example, the information element mentioned is the attribute-value-pair “SIP-Authentication-Scheme” within the grouped attribute-value-pair “SIP-Auth-Data-Item”, which is a mandatory information element in a MAR command. This attribute-value-pair (AVP) is set to contain a specific value such as for example “Provide-Auth-Scheme”.

A private user identity, which is not provided to the network due to the missing authorization header, is derived for the MAR* command (in particular the user-name AVP therein) from a public user identity being registered. This can e.g. be accomplished by removing a URI (user resource identifier) scheme and the following parts of the URI, if present: port number, URI parameters and headers.

Upon receipt of the authentication request message MAR* from the S-CSCF, the HSS acting as the AAA server identifies whether the predetermined information element, i.e. the AVP “SIP-Authentication-Scheme” according to the present example, is set to the specific value, e.g. “Provide-Auth-Scheme”. If so, it retrieves the authentication scheme to be used for the user in question from the pre-stored information, e.g. in a database, at the HSS. An registration status e.g. of a public user identity is not checked in this embodiment. Thus, a flag that indicates that the identity is pending of the confirmation of the authentication is not updated.

Thereupon, the HSS returns an authentication answer message in the format of a multimedia authentication answer (MAA) command to the S-CSCF, cf. MAA* in FIG. 2. In this message, the authentication scheme to be used for the user is included, for example in the AVP “SIP-Authentication-Scheme” within the grouped AVP “SIP-Auth-Data-Item”. Additionally, the thus returned MAA* message may include a result code indicating a successful AAA operation, e.g. DIAMETER_SUCCESS.

After having inquired the scheme to be used by means of the inquiring procedure described above, the S-CSCF is enabled to continue to authenticate the user to be authenticated by using the authentication scheme inquired. This subsequent authentication procedure is exemplarily indicated in FIG. 2 by a dotted box including various exemplary message transfers to follow.

Yet, if the S-CSCF has received a MAA* command with an authentication scheme having a value “HTTP Digest”, it does not send right away the second MAR message. This is due to the S-CSCF not being able to send a MAR command in the proper way since it does not have all parameters needed, which in turn is due to the lacking authorization header in the REGISTER message. Instead it challenges the UE by sending a message “401 Unauthorized” with nonce. The UE will then use the nonce, it calculates the response and sends a REGISTER message with authorization header. The S-CSCF receives the REGISTER message and sends a MAR command to the HSS so that the message then includes all the parameters the HSS needs. The HSS then sends a MAA command, and so on.

If the S-CSCF has received a MAA* command with an authentication scheme having a value “Early IMS”, it sends right away the second MAR command or, in case of the second embodiment described below, it does not send the MAR command, because it already received an IP address in the MAA* command. If the S-CSCF has received a MAA* command with an authentication scheme having a value “IMS AKA” (AKA=Authentication and Key Agreement), it sends right away the second MAR command or, in case of the second embodiment described below, it does not send the MAR command, because it already received authentication vectors in the MAA* command.

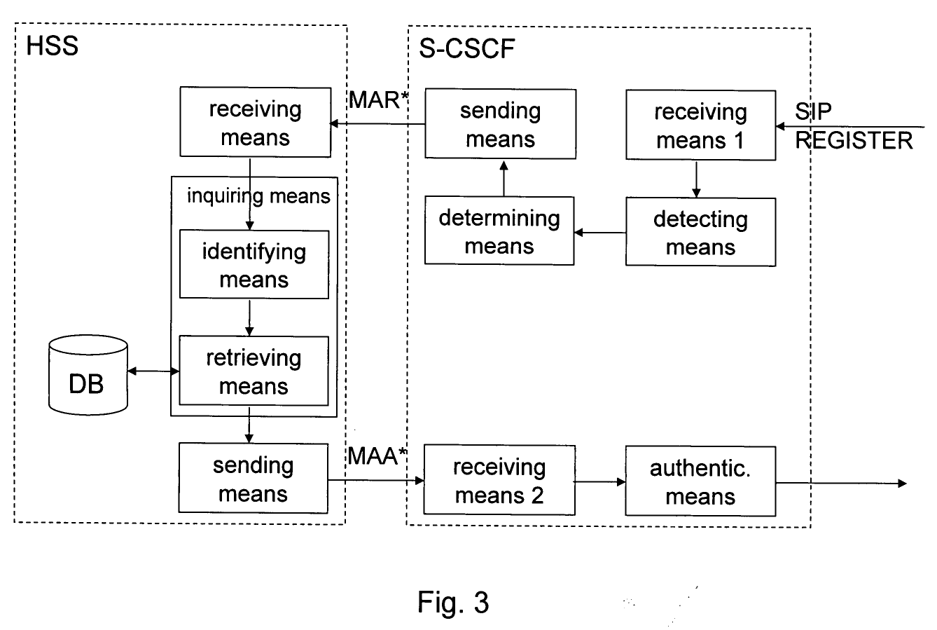

FIG. 3 shows a schematic block diagram of a session control server and an AAA server according to an embodiment of the present invention. Thereby, a system according to an embodiment of the present invention is illustrated, which comprises a session control server and an AAA server. Alternatively, the present invention also covers the single network elements taken alone.

In FIG. 3, arrows between the individual functional blocks indicate the signal flow directions. It is to be noted that only those functional blocks and signal flows are illustrated, which are relevant for the understanding of the present invention and its embodiments.

FIG. 3 is in line with the foregoing explanations, the session control server is illustrated by a serving call session control function S-CSCF and the AAA server is illustrated by a home subscriber server HSS.

The S-CSCF again supports at least two authentication schemes and receives, by means of a first receiving means thereof, a registration request SIP REGISTER without an authorization header. The request is passed on to detecting means for detecting that the registration request does not contain an authorization header, and further to determining means for determining that the registration request leaves undefined the authentication scheme to be used for authenticating the user. The S-CSCF according to the present embodiment further comprises sending means for sending an inquiry MAR* to the AAA server HSS, inquiring which authentication scheme is to be used for authenticating the user, said inquiry containing an identity of the user. The inquiry sent by the sending means is an authentication request message MAR*, in which a predetermined information element regarding the authentication scheme is set to a specific value indicating that the authentication scheme to be used is inquired, as already described above.

For receiving an inquiry answer from the AAA server, the S-CSCF further comprises second receiving means. Authenticating means of the S-CSCF are for authenticating the user to be authenticated by using the authentication scheme inquired, wherein the further procedure of authentication is merely indicated by an arrow to the right hand side in FIG. 3.

The AAA server HSS of the present embodiment comprises receiving means for receiving the inquiry MAR* from the S-CSCF, inquiring means for inquiring which authentication scheme is to be used for authenticating the user, and sending means for returning an authentication answer message to the session control server, in which message the authentication scheme to be used for the user is included.

In the depicted embodiment, the inquiring means further comprises identifying means for identifying that the predetermined information element, e.g. “SIP-Authentication-Scheme” in the MAR* command, is set to a specific value, e.g. “Provide-Auth-Scheme”, and retrieving means for retrieving the authentication scheme to be used from the pre-stored information. This information is held in a database or any other memory means of the HSS, thus enabling that the inquiring is based on an identity of the user and pre-stored information at the AAA server on a mapping between user identities and usable authentication schemes.

Although not described in detail here, the messages and/or commands transferred are equivalent to those described in connection with FIG. 2, thus being denoted by the same abbreviations.

### Solution According to a Second Embodiment of the Present Invention

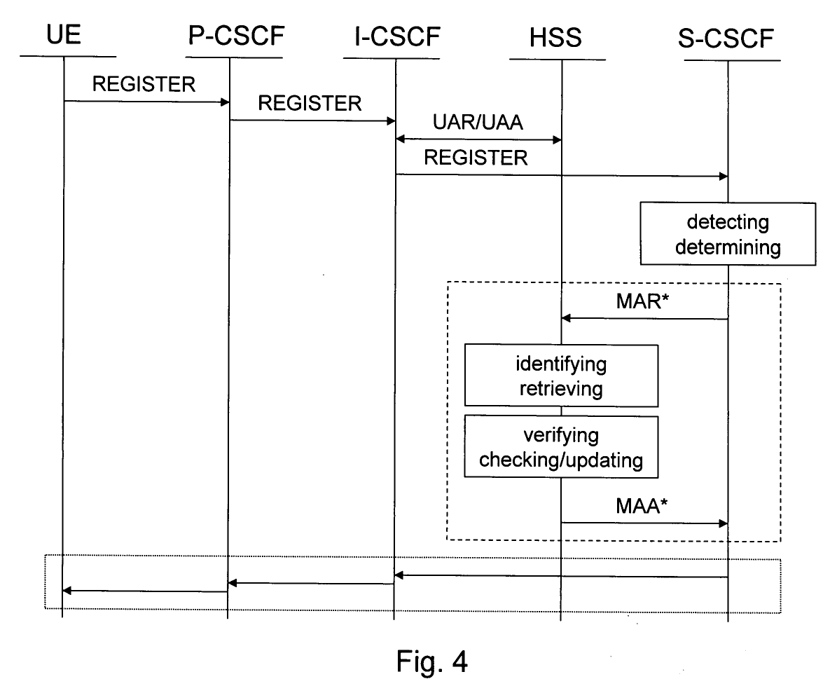

FIG. 4 shows a signaling diagram of an authentication method according to a second embodiment of the present invention, which second embodiment is a further development of the first embodiment described above. Accordingly, a description of like parts of the embodiments is mostly omitted here with reference to a respective description above. For example, the steps from the first REGISTER message until the identifying and retrieving at the HSS of FIG. 4 are similar to those of FIG. 2.

That is, upon receipt of the authentication request message MAR* from the S-CSCF, the HSS acting as the AAA server identifies whether the predetermined information element, i.e. the AVP “SIP-Authentication-Scheme” according to the present example, is set to the specific value, e.g. “Provide-Auth-Scheme”. If so, it retrieves the authentication scheme to be used for the user in question from the pre-stored information, e.g. in a database, at the HSS.

Subsequently, in addition to the operation of the first embodiment, the HSS performs a verifying operation in which the type of authentication scheme retrieved is verified. Thereupon, in response to a verifying result, an answer message MAA* is set up accordingly and a registration status e.g. of a public user identity is checked in this embodiment. If so, a flag that indicates that the identity is pending of the confirmation of the authentication is updated.

In detail, the verifying and checking operations function as follows:
If the authentication scheme retrieved is an HTTP Digest authentication, the HSS sends a MAA* command including the authentication scheme (and a realm). Further in this case, a registration status e.g. of a public user identity is not checked, and thus a flag that indicates that the identity is pending of the confirmation of the authentication is not updated in a database of the HSS.
Otherwise, if the authentication scheme retrieved is an IMS AKA scheme, the HSS calculates authentication vectors and sends them in a MAA* command to the inquiring S-CSCF. Thus, the MAA* command in this case includes the authentication scheme and the authentication vectors calculated. Further in this case, a registration status e.g. of a public user identity is checked and a corresponding flag (that indicates that the identity is pending of the confirmation of the authentication) is updated in a database of the HSS, if needed.
On the other hand, if the authentication scheme retrieved is an Early IMS Security scheme, the HSS sends an IP address and the authentication scheme retrieved in a MAA* command to the S-CSCF. Further in this case, a registration status e.g. of a public user identity is checked and a corresponding flag (that indicates that the identity is pending of the confirmation of the authentication) is updated in a database of the HSS, if needed.

Thereupon, the HSS returns an accordingly adapted authentication answer message in the format of a multimedia authentication answer (MAA) command to the S-CSCF, cf. MAA* in FIG. 4. Hence, according to the present embodiment, the HSS decides what kind of MAA command it sends.

After having inquired the scheme to be used by means of the inquiring procedure described above, the S-CSCF is enabled to continue to authenticate the user to be authenticated by using the authentication scheme inquired. This subsequent authentication procedure is indicated in FIG. 4 by a dotted box including various messages to follow.

By virtue of the verifying and checking operations of the present embodiment, it is possible to avoid an extra MAR/MAA command pair as shown in FIG. 2 above, if the authentication scheme is “IMS AKA” or “Early IMS”. This is due to the fact that the HSS is able to calculate the authentication vectors and/or to send the IP address even when the S-CSCF does not know the authentication scheme to be used.

However, if the authentication scheme is HTTP Digest authentication, the HSS will not be able to calculate a response or a string H(A1), because the S-CSCF has not been able to send all parameters needed for an HTTP Digest authentication in the MAR* command. Thus, in this case, only the authentication scheme is returned. Accordingly, as already described above, if the S-CSCF has received a MAA* command with an authentication scheme having a value “HTTP Digest”, it sends a message “401 Unauthorized”. After the UE receives the message “401 Unauthorized”, it sends a new REGISTER message (not shown), and when the S-CSCF receives it, the S-CSCF sends the second MAR command (not shown) as now it is able to send all the parameters the HSS needs.

For example, if the S-CSCF has received a MAA* command with an authentication scheme having a value “Early IMS”, it does not send a MAR command, because it already received an IP address in the MAA* command. And, if the S-CSCF has received a MAA* command with an authentication scheme having a value “IMS AKA”, it does not send a MAR command, because it already received authentication vectors in the MAA* command.

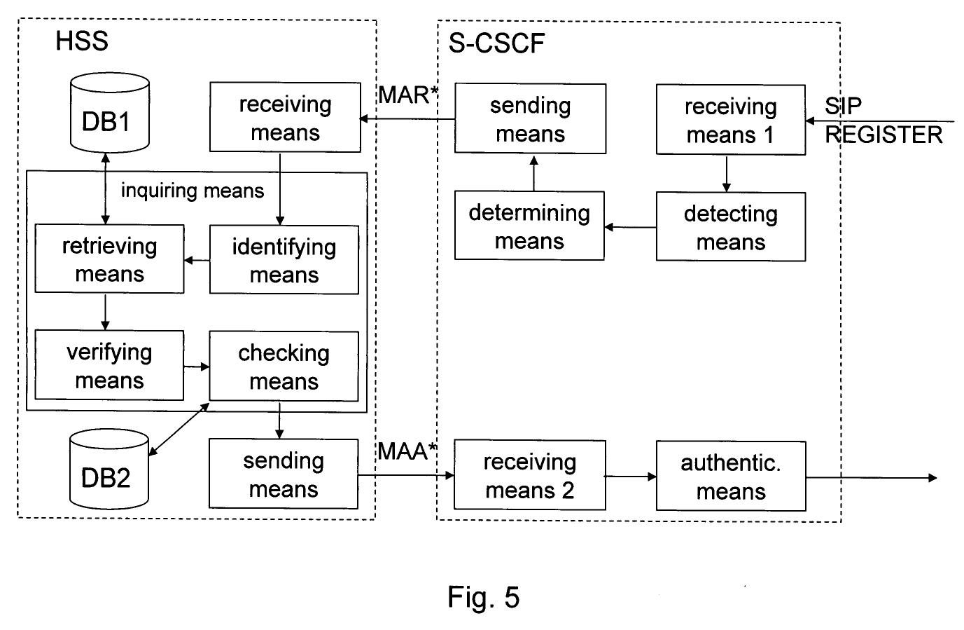

FIG. 5 shows a schematic block diagram of a session control server and an AAA server according to a second embodiment of the present invention. The network elements according to this embodiment are rather similar to those of the first embodiments (especially the session control server), and thus mostly only the differences are described in the following.

The authentication server HSS depicted in FIG. 4 also comprises receiving means for receiving the inquiry MAR* from the S-CSCF, inquiring means for inquiring which authentication scheme is to be used for authenticating the user, and sending means for returning an authentication answer message to the session control server, in which message the authentication scheme to be used for the user is included as well as, if appropriate, the authentication vectors or the IP address.

The inquiring means according to the present embodiment comprises identifying and retrieving means according to the first embodiment. Additionally, it comprises verifying means for verifying the authentication scheme retrieved and checking means for checking a registration status e.g. of a public user identity. The operation of the verifying means and the checking means is described in detail in connection with respective steps in FIG. 4. If an updating of a flag (that indicates that the identity is pending of the confirmation of the authentication) with respect to the registration status is needed, the checking means is further for updating the respective flag in a database. Although two different databases are shown in FIG. 5, i.e. DB1 for storing a mapping between user identities and authentication schemes and DB2 for storing registration status and corresponding flags, it is also conceivable that this information is stored in only one database which is accessed by both the retrieving means and the checking means.

The sending means of the second embodiment is further adapted to set up an answer message MAA* in accordance with a verifying result of the verifying means.

Stated in general terms, the network elements and the system comprised of the network elements of FIG. 3 or FIG. 5 are configured to perform any of the methods of authentication as described throughout this description and/or the claims. According to another embodiment of the present invention, this could also be accomplished by respective computer program products being loadable into a memory of a digital processing means of a network element in a communication system and comprising software code portions for performing, when said product is run on said digital processing means.

In general, it is also to be noted that the mentioned functional elements, e.g. detecting means or inquiring means according to the present invention can be implemented by any known means, either in hardware and/or software, respectively, if it is only adapted to perform the described functions of the respective parts. For example, the retrieving means of the AAA server can be implemented by any data processing unit, e.g. a microprocessor, being configured to retrieving the authentication scheme to be used from pre-stored information as defined by the appended claims. The mentioned parts can also be realized in individual functional blocks or by individual devices, or one or more of the mentioned parts can be realized in a single functional block or by a single device. Correspondingly, the above illustration of FIG. 3 or FIG. 5 is only for illustrative purposes and does not restrict an implementation of the present invention in any way.

Furthermore, method steps likely to be implemented as software code portions and being run using a processor at one of the peer entities are software code independent and can be specified using any known or future developed programming language such as e.g. C, C++, and Assembler. Method steps and/or devices or means likely to be implemented as hardware components at one of the peer entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

[First Additional Proposal]

Another problem which is present in the above described network scenario of a Diameter SIP application in IMS or PoC systems is the following.

According to the above-mentioned Internet-Draft on the Diameter SIP application, both the Diameter server, i.e. the HSS for example, and the Diameter client, i.e. the S-CSCF for example, can perform a final authentication check. If the HSS performs the authentication, it receives all parameters needed for the authentication from the S-CSCF. If the S-CSCF performs the authentication, it receives a string H(A1) obtained by applying a checksum algorithm according to RFC2617 from the HSS. In this case, the algorithm used for calculating H(A1) must be the MD5 algorithm. The IETF Internet-Draft specifies that the HSS decides, if it sends the H(A1) to the Diameter client or not. The Diameter client is however not told, based on what criteria the HSS makes the decision. This problem has not been addressed by any known prior art.

According to the present additional proposal, the S-CSCF notifies the HSS in a MAR command, which network element, i.e. client or server, performs the final authentication, i.e. calculates and verifies a Digest response in HTTP Digest authentication.

Namely, the S-CSCF is configured with the information on which network element performs the final authentication, i.e. the S-CSCF or the HSS. The S-CSCF passes this information to the HSS by using a new attribute-value-pair AVP in a MAR command. The new AVP is exemplarily named “Rsp calc NE” and is of enumerated type. The ABNF (Augmented Backus-Naur Form) of the MAR command is thus amended as illustrated below by means of bold letters in italics:

< Multimedia-Auth-Request > ::=

< Diameter Header: 303, REQ, PXY, 16777216 >
< Session-Id >
{ Vendor-Specific-Application-Id }
{ Auth-Session-State }
{ Origin-Host }
{ Origin-Realm }
{ Destination-Realm }
{ Destination-Host }
{ User-Name }
{ Public-Identity }
{ SIP-Auth-Data-Item}
{ SIP-Number-Auth-Items }
{ Server-Name }

[symbol]

*[ AVP ]
*[ Proxy-Info ]
*[ Route-Record ]

Then, the HSS checks the new AVP in the received MAR command. If the AVP has a value indicating the S-CSCF, the HSS calculates the H(A1) and sends it in a MAA command to the S-CSCF. If the AVP has a values indicating the HSS, the HSS performs the authentication, if it has available all parameters needed for the authentication.

In this additional proposal, it is not required that an authentication request message such as a MAR command is received with a predetermined information element regarding the authentication scheme, which is set to a specific value indicating that the authentication scheme to be used is inquired, such as for example “Provide-Auth-Scheme”.

It is an advantage of this proposal that both the S-CSCF (i.e. Diameter client) and the HSS (i.e. Diameter server) know which network element performs the final authentication. Thus, both network elements know which parameters they need to send in MAR/MAA commands.

[Second Additional Proposal]

A further problem which is present in the above described network scenario of a Diameter SIP application in IMS or PoC systems is the following.

According to the HTTP Digest authentication of RFC2617, an Authentication-Info header is used by the server to communicate some information regarding the successful authentication in the response. However, sending of the Authentication-Info header is not mandatory.

If the HSS performs the Digest response calculation and verification in the HTTP Digest authentication scheme, it can also calculate the parameter “response-auth” of the Authentication-Info header and sent it within a MAA command to the S-CSCF. The sending of the parameter “response-auth” within a MAA command is specified in the IETF Diameter SIP Application draft as mentioned above. The response-auth named Digest-Response-Auth AVP is one AVP of the grouped AVP SIP-Authentication-Info. The SIP-Authentication-Info AVP is one AVP of the grouped AVP SIP-Auth-Data-Item as mentioned above.

Hence, there is no way that the HSS can know whether it should calculate the response-auth parameter or not, and this problem has not been solved by any known prior art.

According to the present additional proposal, the S-CSCF notifies the HSS in the MAR command, whether the HSS shall calculate the parameter response-auth and shall send the SIP-Authentication-Info AVP in the MAA command.

Namely, the S-CSCF is configured with the information on whether it sends the Authentication-Info header or not. The S-CSCF passes this information to the HSS by using a new AVP in MAR command, which is exemplarily named “Send-Auth-Info”. The new AVP is of enumerated type and is added to the grouped AVP SIP-Authorization as an optional AVP. The ABNF (Augmented Backus-Naur Form) of the SIP-Authorization is as follows. The change to the SIP-Authorization presented in the IETF Diameter SIP Application is shown by means of bold letters in italics:

SIP-Authorization ::= < AVP Header: xx13 >

{ Digest-Username }
{ Digest-Realm }
{ Digest-Nonce }
{ Digest-URI }
{ Digest-Response }
[ Digest-Algorithm ]
[ Digest-CNonce ]
[ Digest-Opaque ]
[ Digest-QoP ]
[ Digest-Nonce-Count ]
[ Digest-Method]
[ Digest-Entity-Body-Hash ]
* [ Digest-Auth-Param ]

[symbol]

* [ AVP ]

The HSS checks the new AVP. If the AVP has a value “Yes”, the HSS calculates the response-auth parameter and sends it in a MAA command within AVP SIP-Authentication-Info to the S-CSCF. If the AVP has a value “No”, the HSS does not calculate the response-auth parameter and it does not send the AVP SIP-Authentication-Info within a MAA command

In this additional proposal, it is not required that an authentication request message such as a MAR command is received with a predetermined information element regarding the authentication scheme, which is set to a specific value indicating that the authentication scheme to be used is inquired, such as for example “Provide-Auth-Scheme”.

It is an advantage of this proposal that the HSS knows whether it calculates the Response-Auth parameter and sends it in a MAA command within the AVP SIP-Authentication-Info or not.

[Third Additional Proposal]

A further problem which is present in the above described network scenario of a Diameter SIP application in IMS or PoC systems is the following.

In 3GPP TS 29.228 and the above-mentioned Diameter SIP Application Internet-Draft, the logic of MAR/MAA commands provides for instructions on how the HSS handles registration status and S-CSCF name. According to 3GPP TS29.228 as mentioned above, the logic of authentication is applied only for a registration case with a SIP REGISTER message. According to the respective description therein, it is not even reasonable to apply such a logic in a different case. However, in a HTTP digest authentication even further methods other than REGISTER can be authenticated.

According to prior art solutions, a registration status and S-CSCF name are handled in the HSS in exactly the same way for both REGISTER and non-REGISTER procedures, when the HSS has received a MAR command from the S-CSCF and the authentication type is HTTP Digest.

According to the present additional proposal, the kind of procedure in question is checked in the HSS in the MAR/MAA logic before a registration status and S-CSCF name are checked. Then, the logic on how to handle the registration status and the S-CSCF name is based on the kind of the procedure in question.

Namely, when the HSS receives a MAR command and the authentication type is a HTTP digest authentication, the HSS proceeds as described in 3GPP TS 29.228 until it checks the registration status and the S-CSCF name. Subsequently, the kind of procedure in question is checked at the HSS before registration status and S-CSCF checking. If the procedure is of REGISTER type, the HSS checks the registration status and the S-CSCF name. If the procedure is of non-REGISTER type, the HSS checks the registration status first. If the registration status is “not registered” or “unregistered”, the HSS sends a MAR command with a reason code identifying the situation, such as for example DIAMETER_ERROR_IDENTITY_NOT_REGISTERED, to the S-CSCF. If the registration status is “registered”, the HSS checks the S-CSCF name received from the S-CSCF in a MAR command against one stored in a database of the HSS. If these do not match each other, the HSS sends a MAR command with a reson code identifying the situation, such as for example DIAMETER_AUTHENTICATION_REJECTED, to the S-CSCF.

It is an advantage of the thus presented proposal that the logic of the HSS is corrected as compared to the prior art or conventional solutions. It does not accept the authentication of other procedures than REGISTER, if the user is not registered and the non-REGISTER message is not received from the same S-CSCF name than the one stored at the HSS.

According to the present invention and its embodiments, there is presented an authentication of a user of a communication system comprising a session control server and an authentication, authorization and accounting server, AAA server, wherein the communication system supports at least two separate authentication schemes, comprising the steps of determining, at the session control server, that a registration request from the user to be authenticated leaves undefined the authentication scheme to be used for authenticating the user; and inquiring, from the AAA server, which authentication scheme is to be used for authenticating the user, said inquiring being based on an identity of the user and pre-stored information at the AAA server on a mapping between user identities and usable authentication schemes. In principle, the idea of the present invention is that an authentication scheme is stored in an AAA server such as a HSS and that a session control server such as a S-CSCF asks for the authentication scheme at the AAA server.

Even though the invention is described above with reference to the examples according to the accompanying drawings, it is clear that the invention is not restricted thereto. Rather, it is apparent to those skilled in the art that the present invention can be modified in many ways without departing from the scope of the inventive idea as disclosed in the appended claims.

1. A method of authentication for authenticating a user of a communication system comprising a session control server and an authentication server, wherein the communication system supports at least two separate authentication schemes, comprising the steps of:
determining, at the session control server, that a registration request from a user to be authenticated leaves undefined an authentication scheme to be used for authenticating the user; and
inquiring, from the authentication server, about which authentication scheme is to be used for authenticating the user,
said inquiring being based on an identity of the user and pre-stored information at the authentication server concerning a mapping between users' identities and usable authentication schemes.

2. The method according to claim 1, wherein the step of determining further comprises the step of:
detecting that the registration request does not contain an authorization header.

3. The method according to claim 1, wherein the step of inquiring comprises the step of:
sending an authentication request message from the session control server to the authentication server, in which authentication request message a predetermined information element regarding the authentication scheme is set to a specific value for indicating an inquiry of the authentication scheme to be used.

4. The method according to claim 3, wherein the step of inquiring further comprises the step of:
identifying, at the authentication server, that the predetermined information element regarding the authentication scheme is set to the specific value; and
retrieving the authentication scheme to be used from the pre-stored information.

5. The method according to claim 4, wherein the step of inquiring further comprises the step of:
returning an authentication answer message from the authentication server to the session control server, in which authentication answer message the authentication scheme to be used for authenticating the user is included.

6. The method according to claim 5, wherein the authentication answer message further includes a result code indicating a successful authentication operation.

7. The method according to claim 4, wherein the step of inquiring further comprises the step of:
verifying, at the authentication server, the authentication scheme retrieved.

8. The method according to claim 7, wherein the step of inquiring further comprises the step of:
returning an authentication answer message from the authentication server to the session control server, in accordance with a verifying result of the verifying step, in which authentication answer message at least the authentication scheme to be used for authenticating the user is included.

9. The method according to claim 8, wherein the authentication answer message further includes authentication vectors calculated at the authentication server in response to the verifying result.

10. The method according to claim 8, wherein the authentication answer message further includes an Internet Protocol address in response to the verifying result.

11. The method according to claim 8, wherein the authentication answer message further includes a result code indicating a successful authentication operation.

12. The method according to claim 4, wherein the step of inquiring further comprises the step of:
checking, at the authentication server, a registration status of the user; and
updating the registration status at the authentication server, if needed, in response to a checking result of the checking step.

13. The method according to claim 1, further comprising the step of:
authenticating the user to be authenticated by using the inquired about authentication scheme.

14. The method according to claim 1, wherein the session control server is operable in accordance with a session initiation protocol (SIP).

15. The method according to claim 1, wherein the authentication server is operable in accordance with a Diameter protocol.

16. The method according to claim, wherein one of the at least two authentication schemes is an authentication scheme in accordance with Third Generation Partnership Project(3GPP) specifications.

17. The method according to claim 16, wherein the authentication scheme in accordance with 3GPP specifications is an Early Internet Protocol Multimedia Subsystem(IMS) security protocol.

18. The method according to claim 1, wherein one of the at least two authentication schemes is an authentication scheme in accordance with Internet Engineering Task Force(IETF) specifications.

19. The method according to claim 18, wherein the authentication scheme in accordance with IETF specifications is a Hypertext Transfer Protocol (HTTP) digest access authentication protocol.

20. A method of authentication for authenticating a user of a communication system comprising a session control server and an authentication server, wherein the communication system supports at least two separate authentication schemes, the method being performed at the authentication server and comprising the step of:
inquiring about which authentication scheme is to be used for authenticating the user,
said inquiring being based on an identity of the user and pre-stored information at the authentication server concerning a mapping between users' identities and usable authentication schemes.

21. The method according to claim 20, wherein the step of inquiring further comprises the steps of:
receiving an authentication request message from the session control server, in which authentication request message a predetermined information element regarding the authentication scheme is set to a specific value for indicating an inquiry of the authentication scheme to be used;
identifying that the predetermined information element regarding the authentication scheme is set to the specific value; and
retrieving the authentication scheme to be used from the pre-stored information.

22. The method according to claim 21, wherein the step of inquiring further comprises the step of:
returning an authentication answer message to the session control server, in which authentication answer message the authentication scheme to be used for the user is included.

23. The method according to claim 21, wherein the step of inquiring further comprises the step of:
verifying the authentication scheme retrieved.

24. The method according to claim 23, wherein the step of inquiring further comprises the step of:
returning an authentication answer message from the authentication server to the session control server, in accordance with a verifying result of the verifying step, in which authentication answer message at least the authentication scheme to be used for authenticating the user is included.

25. The method according to claim 21, wherein the step of inquiring further comprises the step of:
checking, at the authentication server, a registration status of a user; and
updating the registration status at the authentication server, if needed, in response to a checking result of the checking step.

26. The method according to claim 22, wherein the authentication answer message further includes a result code indicating a successful authentication operation.

27. A session control server of a communication system comprising the session control server and an authentication server, being operable for authenticating a user, wherein the communication system supports at least two separate authentication schemes, comprising:
a receiver configured to receive a registration request from a user to be authenticated;
a determinator configured to determine that the registration request leaves undefined an authentication scheme to be used for authenticating the user; and
a sender configured to send an inquiry to the authentication server for inquiring about which authentication scheme is to be used for authenticating the user, said inquiry containing an identity of the user.

28. The session control server according to claim 27, further comprising:
a detector configured to detect that the registration request does not contain an authorization header.

29. The session control server according to claim 27, wherein the sender is further configured to send an authentication request message to the authentication server, in which authentication request message a predetermined information element regarding the authentication scheme is set to a specific value for indicating the inquiry of the authentication scheme to be used.

30. The session control server according to claim 27, wherein the receiver is further configured to receive an inquiry answer from the authentication server, and further comprising:
an authenticator configured to authenticate the user to be authenticated by using the inquired about authentication scheme.

31. The session control server according to claim 27, wherein the session control server is a call session control function.

32. A session control server of a communication system comprising the session control server and an authentication server, being operable for authenticating a user, wherein the communication system supports at least two separate authentication schemes, comprising:
receiving means for receiving a registration request from a user to be authenticated;
determining means for determining that the registration request leaves undefined an authentication scheme to be used for authenticating the user; and
sending means for sending an inquiry to the authentication server for inquiring about which authentication scheme is to be used for authenticating the user, said inquiry containing an identity of the user.

33. The session control server according to claim 32, further comprising:
detecting means for detecting that the registration request does not contain an authorization header.

34. The session control server according to claim 32, further comprising sending means for sending an authentication request message to the authentication server, in which authentication request message a predetermined information element regarding the authentication scheme is set to a specific value for indicating the inquiry of the authentication scheme to be used.

35. The session control server according to claim 32, further comprising:
receiving means for receiving an inquiry answer from the authentication server; and
authenticating means for authenticating the user to be authenticated by using the inquired about authentication scheme.

36. The session control server according to claim 32, wherein the session control server is a call session control function.

37. An authentication server of a communication system comprising a session control server and the authentication server, being operable for authenticating a user, wherein the communication system supports at least two separate authentication schemes, comprising:
a receiver configured to receive an inquiry from the session control server for inquiring about which authentication scheme is to be used for authenticating the user;
an inquirer configured to inquire which authentication scheme is to be used for authenticating the user,
said inquirer being operable based on an identity of the user and pre-stored information at the authentication server concerning a mapping between users' identities and usable authentication schemes.

38. The authentication server according to claim 37, wherein the receiver is further configured to receive an authentication request message from the session control server, in which authentication request message a predetermined information element regarding the authentication scheme is set to a specific value for indicating the inquiry of the authentication scheme to be used; and further comprising:
an identifier configured to identify that the predetermined information element regarding the authentication scheme is set to the specific value; and
a retriever configured to retrieve the authentication scheme to be used from the pre-stored information.

39. The authentication server according to claim 37, further comprising:
a sender configured to return an authentication answer message to the session control server, in which authentication answer message the authentication scheme to be used for the user is included.

40. The authentication server according to claim 37, further comprising:
a verifier configured to verify the authentication scheme retrieved by the retriever.

41. The authentication server according to claim 40, further comprising:
a sender configured to return an authentication answer message to the session control server in accordance with a verifying result of the verifier, in which authentication answer message at least the authentication scheme to be used for authenticating the user is included.

42. The authentication server according to claim 37, further comprising:
a checker configured to check a registration status of a user; and
an updater configured to update the registration status, if needed, in response to a checking result of the checker.

43. The authentication server according to claim 37, wherein the authentication server is a Diameter server.

44. The authentication server according to claim 37, wherein the authentication server is a home subscriber server.

45. An authentication server of a communication system comprising a session control server and the authentication server, being operable for authenticating a user, wherein the communication system supports at least two separate authentication schemes, comprising:
receiving means for receiving an inquiry from the session control server, for inquiring about which authentication scheme is to be used for authenticating the user;
inquiring means for inquiring which authentication scheme is to be used for authenticating the user,
said inquiring means being operable based on an identity of the user and pre-stored information at the authentication server concerning a mapping between users' identities and usable authentication schemes.

46. The authentication server according to claim 45, further comprising:
receiving means for receiving an authentication request message from the session control server, in which authentication request message a predetermined information element regarding the authentication scheme is set to a specific value for indicating the inquiry of the authentication scheme to be used;
identifying means for identifying that the predetermined information element regarding the authentication scheme is set to the specific value; and
retrieving means for retrieving the authentication scheme to be used from the pre-stored information.

47. The authentication server according to claim 46, further comprising:
sending means for returning an authentication answer message to the session control server, in which authentication answer message the authentication scheme to be used for the user is included.

48. The authentication server according to claim 46, further comprising:
verifying means for verifying the authentication scheme retrieved by the retrieving means.

49. The authentication server according to claim 48, further comprising:
sending means for returning an authentication answer message to the session control server in accordance with a verifying result of the verifier, in which authentication answer message at least the authentication scheme to be used for authenticating the user is included.

50. The authentication server according to claim 46, further comprising:
checking means for checking a registration status of a user; and
updating means for updating the registration status, if needed, in response to a checking result of the checking means.

51. The authentication server according to claim 45, wherein the authentication server is a Diameter server.

52. The authentication server according to claim 45, wherein the authentication server is a home subscriber server.

53. A computer program product embodied on a computer readable medium, the computer program product being loadable into a memory of a digital processing means of a network element in a communication system and comprising software code portions for performing, when said product is run on said digital processing means, a method of authentication for authenticating a user of a communication system comprising a session control server and an authentication server, wherein the communication system supports at least two separate authentication schemes, comprising the steps of:
determining, at the session control server, that a registration request from a user to be authenticated leaves undefined an authentication scheme to be used for authenticating the user; and
inquiring, from the authentication server, about which authentication scheme is to be used for authenticating the user,
said inquiring being based on an identity of the user and pre-stored information at the authentication server concerning a mapping between users' identities and usable authentication schemes.

54. A computer program product embodied on a computer readable medium, the computer program product being loadable into a memory of a digital processing means of a network element in a communication system and comprising software code portions for performing, when said product is run on said digital processing means, a method of authentication for authenticating a user of a communication system comprising a session control server and an authentication server, wherein the communication system supports at least two separate authentication schemes, the method being performed at the authentication server and comprising the step of:
inquiring about which authentication scheme is to be used for authenticating the user,
said inquiring being based on an identity of the user and pre-stored information at the authentication server concerning a mapping between users' identities and usable authentication schemes.

55. A signal carrying an authentication request message in the format of a multimedia authentication request (MAR) command, in which authentication request message an information element “SIP-Authentication-Scheme” is set to a specific value indicating that an authentication scheme is inquired.
